(19) United States
(12) Patent Application Publication
(10) Pub. No.: US 2008/0101827 A1
(43) Pub. Date: May 1, 2008

(54) Image Fixation Apparatus, Image Formation Apparatus Having the Image Fixation Apparatus, and Image Fixation Method

(75) Inventor: Shuhei MORI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/923,473

(22) Filed: Oct. 24, 2007

(30) Foreign Application Priority Data
Oct. 30, 2006 (JP) 2006-293647

(51) Int. Cl. G03G 15/20

(52) U.S. Cl. 399/323

(57) ABSTRACT

The invention provides an image fixation apparatus that includes: an image fixation roller that is made up of a heating roller having a heating element and a pressure-applying roller that is opposed to the heating roller, the heating roller and the pressure-applying roller forming a nip portion; a separation member that contacts the heating roller; and a wheel member provided at a downstream of the separation member, the wheel member having a wheel that rotates when becoming in contact with an image-transfer target material, wherein the wheel member can move relative to the separation member.

### BACKGROUND

1. Technical Field

The present invention generally relates to an image fixation apparatus. More particularly, the present invention relates to an image fixation apparatus having a wheel that is provided at the downstream of a separating nail. The invention further relates to an image formation apparatus that is provided with such an image fixation apparatus.

2. Related Art

A typical electro-photographic toner image formation device is provided with a photosensitive member, an electrification unit, a light exposure unit, and a developing unit. The photosensitive member has a photosensitive layer on its circumferential surface and functions as an image carrier. The electrification unit electrifies the circumferential surface of the photosensitive member in a uniform manner. The light exposure unit selectively exposes the circumferential surface of the photosensitive member, which has been uniformly electrified by the electrification unit, to light so as to form an electrostatic latent image. The developing unit applies a toner, which is a photographic developer, onto the electrostatic latent image formed by the light exposure unit so as to form a visible image (i.e., toner image).

In a typical configuration of a rotary-type image formation apparatus that forms color images, the toner image formation device described above is provided in such a manner that it is opposed to an intermediary image-transfer belt. Such an intermediary-image-transfer-type image formation apparatus transfers one toner image after another, which are sequentially formed on the photosensitive member by the above-mentioned toner image formation device, to the intermediary image-transfer belt. By this means, individual toner images of a plurality of colors (e.g., a yellow toner image, a cyan toner image, a magenta toner image, and a black toner image) are superposed or overlapped onto one another on the intermediary image-transfer belt so as to form a full-color image thereon.

An image fixation apparatus of related art that is built in such an image formation apparatus is configured as follows. A paper separation nail member is provided in the proximity of an image fixation roller (which is a pair of rollers). A spur member is provided on the paper separation nail member. The spur member is configured to rotate as an image-transfer target material moves in contact therewith. The paper separation nail member is configured to be able to move between a first position and a second position. The tip portion of the paper separation nail member is configured to be in contact with the surface of a heat-absorbing layer of the image fixation roller for a predetermined limited duration of time only. Having such a configuration, the image fixation apparatus of related art prevents the heat-absorbing layer from being damaged. As a result thereof, the image fixation apparatus of related art offers an enhanced image-fixation capability, which makes it possible to realize a stable image fixation. An example of the above-described image fixation apparatus of related art is disclosed in JP-A-2001-265141.

Disadvantageously, however, according to the configuration of the image fixation apparatus of related art, since the positional relationship between the paper separation nail member and the spur member is predetermined in a fixed manner, there is a possibility that an undesired impression or trace of the spur member is formed on the image surface of an image-transfer target material. Such a problem is conspicuously observed when thick paper or the like is used as the image-transfer target material.

### SUMMARY

An advantage of some aspects of the invention is to provide an image fixation apparatus that can effectively reduce the formation of any impression or trace caused by the wheel member (spur member) on the image surface of an image-transfer target material such as paper, and further avoid the occurrence of a paper jam malfunction or error. Advantageously, the invention further provides an image formation apparatus that is provided with such an image fixation apparatus. Moreover, the invention provides an image fixation method that offers the same advantageous effects as described above.

In order to address the above-identified problem without any limitation thereto, the invention provides, as a first aspect thereof, an image fixation apparatus including: an image fixation roller that is made up of a heating roller having a heating element and a pressure-applying roller that is opposed to the heating roller, the heating roller and the pressure-applying roller forming a nip portion; a separation member that contacts the heating roller; and a wheel member provided at a downstream of the separation member, the wheel member having a wheel that rotates when becoming in contact with an image-transfer target material, wherein the wheel member can move relative to the separation member. With such a configuration, the invention makes it possible to avoid the occurrence of a paper jam malfunction or error, and further to reduce the formation of any impression or trace caused by the wheel member.

In the configuration of the image fixation apparatus according to the first aspect of the invention described above, it is preferable that the wheel member is supported by an elastic member in such a manner that it can move relative to the separation member. With such a configuration, the wheel member can return to its original position after the passing of the image-transfer target material.

In the configuration of the image fixation apparatus according to the first aspect of the invention described above, it is preferable that the separation member has an elongated hole, and the wheel member can move relative to the separation member along the elongated hole. With such a configuration, it is possible to determine the moving direction thereof.

In the configuration of the image fixation apparatus according to the first aspect of the invention described above, it is preferable that the elongated hole has an elastic member inside thereof. With such a configuration, the wheel member can return to its original position after the passing of the image-transfer target material.

It is preferable that the image fixation apparatus according to the first aspect of the invention described above further includes an after-image-fixation roller provided at a downstream of the heating roller and the pressure-applying roller, where, in such a configuration, the wheel member can move relative to the separation member in a direction substantially parallel to a nip portion coupling line that passes through a nip portion outlet that is formed by the heating roller and the pressure-applying roller and a nip portion inlet of the after-image-fixation roller. With such a configuration, the invention makes it possible to avoid the occurrence of a paper jam malfunction or error.

It is preferable that the image fixation apparatus according to the first aspect of the invention described above further includes an after-image-fixation roller provided at a downstream of the heating roller and the pressure-applying roller, where, in such a configuration, the wheel member can move relative to the separation member in a direction substantially perpendicular to a nip portion coupling line that passes through a nip portion outlet that is formed by the heating roller and the pressure-applying roller and a nip portion inlet of the after-image-fixation roller. With such a configuration, the invention makes it possible to avoid the occurrence of a paper jam malfunction or error, and further to reduce the formation of any impression or trace caused by the wheel member even when a thick-type of image-transfer target material is used.

In order to address the above-identified problem without any limitation thereto, the invention provides, as a second aspect thereof, an image formation apparatus that is provided with the image fixation apparatus according to the first aspect of the invention, the image formation apparatus including: an image carrier; a developer carrier that develops a latent image formed on the image carrier; an intermediary image-transfer section that transfers an image developed on the image carrier by the developer carrier; a secondary image-transfer section that transfers an image on the intermediary image-transfer section to an image-transfer target material; and the above-mentioned image fixation apparatus that fixes an image on the image-transfer target material. With such a configuration, the invention makes it possible to avoid the occurrence of a paper jam malfunction or error, and further to reduce the formation of any impression or trace caused by the wheel member.

In order to address the above-identified problem without any limitation thereto, the invention provides, as a third aspect thereof, an image fixation method including: an image-transfer target material passing through a nip portion formed by a heating roller having a heating element and a pressure-applying roller that is opposed to the heating roller; and the image-transfer target material becoming in contact with a wheel member that is provided at a downstream of a separation member, the wheel member being able to move relative to the separation member. With such a configuration, the invention makes it possible to avoid the occurrence of a paper jam malfunction or error, and further to reduce the formation of any impression or trace caused by the wheel member.

### BRIEF DESCRIPTION OF THE DRAWINGS

The invention will be described with reference to the accompanying drawings, wherein like numbers reference like elements.

FIG. 1 is a vertically sectional side view that schematically illustrates the longitudinal section of an image fixation apparatus according to a first aspect of the invention.

FIG. 2 is a plan view that schematically illustrates the image fixation apparatus according to the first aspect of the invention.

FIG. 3 is an enlarged view of a paper scraping-off nail member and its peripheral components according to the first aspect of the invention.

FIG. 4 is an operational view that schematically illustrates the image fixation apparatus according to the first aspect of the invention.

FIG. 5 is an enlarged view of a paper scraping-off nail member and its peripheral components according to a second aspect of the invention.

FIG. 6 is an operational view that schematically illustrates the image fixation apparatus according to the second aspect of the invention.

FIG. 7 is an enlarged view of an elongated hole portion according to the second aspect of the invention.

FIG. 8 is an enlarged view of a paper scraping-off nail member and its peripheral components according to a third aspect of the invention.

FIG. 9 is an operational view that schematically illustrates the image fixation apparatus according to the third aspect of the invention.

FIG. 10 is an enlarged view of a paper scraping-off nail member and its peripheral components according to a fourth aspect of the invention.

FIG. 11 is an operational view that schematically illustrates the image fixation apparatus according to the fourth aspect of the invention.

FIG. 12 is a vertically sectional side view that schematically illustrates the longitudinal section of an image formation apparatus according to an exemplary embodiment of the invention.

### DESCRIPTION OF EXEMPLARY EMBODIMENTS

With reference to the accompanying drawings, an exemplary embodiment of the invention is described below.

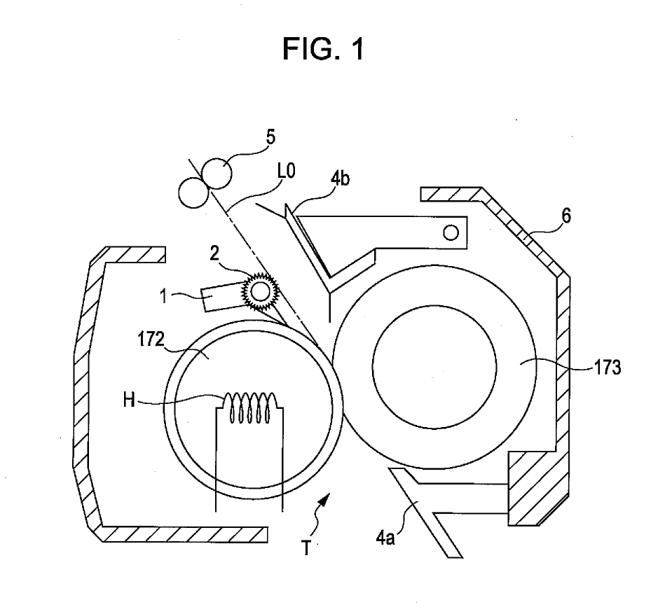

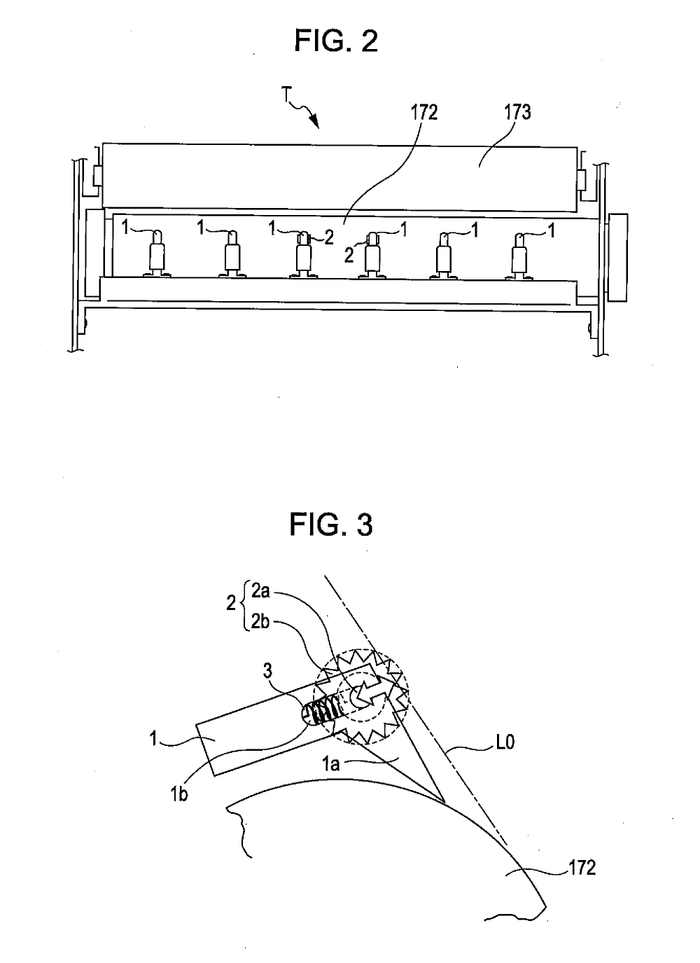

FIG. 1 is a sectional view that schematically illustrates an example of an image fixation apparatus according to a first embodiment of the invention. FIG. 2 is a plan view that schematically illustrates an example of the image fixation apparatus according to the first embodiment of the invention. In these drawings, reference numeral 1 denotes a paper scraping-off nail member. Reference numeral 2 denotes a spur member. Reference numeral 4 collectively denotes a guide member, where reference numerals 4a and 4b denote an entrance-side guide member and an exit-side guide member, respectively. Reference numeral 5 denotes “after-image-fixation” roller (“after” means that it is provided at the downstream side). Reference numeral 6 denotes a housing. Reference character T denotes an image fixation roller. Reference numeral 172 denotes a heating roller. Reference character H denotes a heater. Reference numeral 173 denotes a pressure-applying roller. Finally, reference symbol L0 denotes a nip portion coupling line.

As illustrated in FIG. 1, the image fixation apparatus is made up of, though not limited thereto, the heating roller 172, the pressure-applying roller 173, the paper scraping-off nail member 1, the spur member 2, the guide member 4, the after-image-fixation roller 5, and the housing 6. The heating roller 172 is a cylindrical member that is equipped with the built-in heater H. Both ends of the heating roller 172 are supported in such a manner that it can rotate. A driving device that is not shown in these drawings drives the heating roller 172. The pressure-applying roller 173, which is provided in parallel with the heating roller 172, rotates in a coupled-driven manner. The master-driving heating roller 172 and the slave-driven pressure-applying roller 173 provided opposed to each other form a nip portion. The pressure-applying roller 173 applies a pressing force onto a sheet of paper S toward the heating roller 172. The housing 6 encases the heating roller 172, the pressure-applying roller 173, the entrance-side guide member 4a, the exit-side guide member 4b, and the paper scraping-off nail member 1 to provide a mechanical support therefor. The entrance-side guide member 4a is provided at the inlet of the image fixation roller T to guide the paper S, which is an example of an image-transfer target material, whereas the exit-side guide member 4b is provided at the outlet of the image fixation roller T to guide the paper S. The paper scraping-off nail member 1 separates the paper S from the heating roller 172 to which the paper S sticks.

Next, the operation of the image fixation apparatus having the above-described configuration is briefly explained below. The paper S passes through the entrance-side guide member 4a, and then passes through the nip portion formed by the heating roller 172 and the pressure-applying roller 173. After passing through the nip portion, the paper scraping-off nail member 1 scrapes off the paper S that sticks to the heating roller 172. The removed paper S goes through the spur member 2. Thereafter, the paper S passes through the exit-side guide member 4b. Finally, the paper S is transported toward the after-image-fixation roller 5, which is provided at the downstream side of the above-explained paper transport channel. The nip portion coupling line L0 is a line that passes through the nip portion outlet that is formed by the heating roller 172 and the pressure-applying roller 173 and the nip portion inlet of the after-image-fixation roller 5.

As illustrated in FIG. 2, the spur members 2 are selectively attached to, among a plurality of the paper scraping-off nail members 1, ones that are arranged at the central region of the heating roller 172 viewed along the width direction of the paper S. Since the temperature of the central region of the heating roller 172 viewed along the width direction of the paper S is relatively high in comparison with the end regions thereof, the paper S shows a stronger adhesion property for the central region of the heating roller 172 in comparison with the end regions thereof. For this reason, in the example described herein, the spur members 2 are selectively attached to not all but some of the plurality of the paper scraping-off nail members 1 that are arranged at the central region of the heating roller 172 viewed along the width direction of the paper S. If the spur members 2 are arranged as described above, it is possible to realize a low-cost efficient configuration. Notwithstanding the foregoing, the spur member 2 may be attached to each of the paper scraping-off nail members 1. As a further alternative configuration, the spur member 2 may be attached to every other paper scraping-off nail member 1.

FIG. 3 is an enlarged view of the paper scraping-off nail member 1 and its peripheral components. As illustrated in FIG. 3, the paper scraping-off nail member 1 has a tip portion 1a and an elongated hole 1b. The spur axis 2a of the spur member 2 penetrates through the elongated hole 1b of the paper scraping-off nail member 1. The tip portion 1a of the paper scraping-off nail member 1 becomes in contact with the surface of the heating roller 172 so as to separate the paper S from the heating roller 172. The elongated hole 1b is formed to be substantially perpendicular to the nip portion coupling line L0. In addition to the spur axis 2a, the spur member 2 has spur wheels (rowels) 2b. Each of the spur wheels 2b is attached at one end of the spur axis 2a, which is inserted through the elongated hole 1b of the paper scraping-off nail member 1. One end of a spring 3 is connected to (the inner wall of) the elongated hole 1b of the paper scraping-off nail member 1, whereas the other end thereof is connected to the spur axis 2a of the spur member 2. As an example of alternative configurations, a cylinder that surrounds the spur axis 2a may be provided so as to support the spring 3.

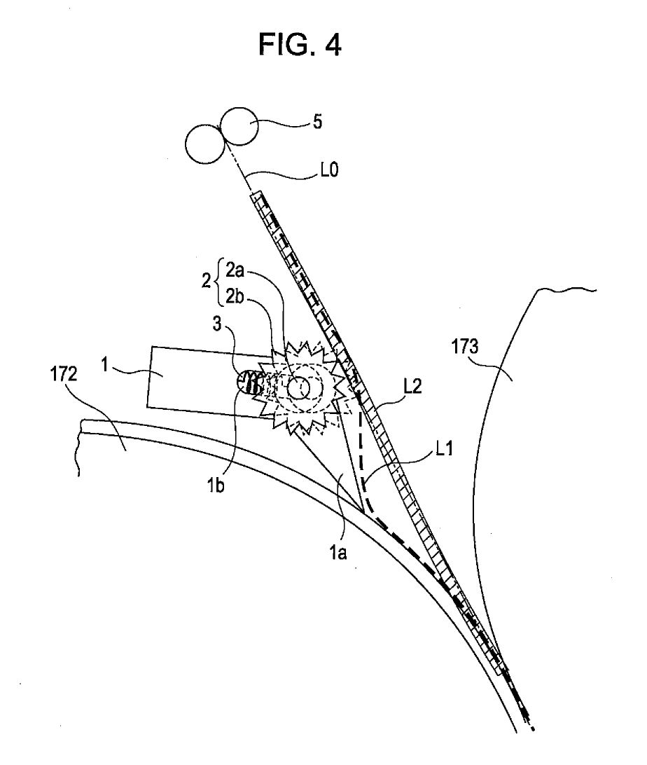

Next, the operation of the image fixation apparatus according to the first embodiment of the invention is described below. FIG. 4 is a diagram that schematically illustrates the operation of the spur member 2 with respect to the transport channel (i.e., transport path) of the paper S. In this drawing, the dotted line L1 denotes a first paper transport channel on which a so-called normal plain paper or any equivalent paper having substantially the same thickness as that of the normal plain paper passes, whereas the hatched line L2 denotes a second paper transport channel on which a thick-type paper having a thickness larger than that of the normal plain paper passes. It should be noted that the second paper transport channel L2 constitutes substantially the same path as the nip portion coupling line L0.

Firstly, a reference is made to the first paper transport channel L1 on which a normal plain paper travels. After passing through the nip portion of the image fixation roller T, the paper S is transported while being adhered to the heating roller 172 until it is separated therefrom by the tip portion 1a of the paper scraping-off nail member 1. After being scraped off by the tip portion 1a of the paper scraping-off nail member 1 from the heating roller 172, the paper S becomes in contact with the spur wheels 2b of the spur member 2. In this way, it is possible to prevent the tip portion 1a of the paper scraping-off nail member 1 from becoming in contact with the image surface of the paper S. Subsequently, the paper S passes through the guide member 4, and transported toward the after-image-fixation roller 5.

Next, a reference is made to the second paper transport channel L2 on which a thick-type paper travels. After passing through the nip portion of the image fixation roller T, the paper S is immediately separated by itself from the heating roller 172. Then, the paper S is transported toward the after-image-fixation roller 5. During transport of the paper 5, it becomes in contact with the spur wheels 2b of the spur member 2. However, the spur wheels 2b do not get pressed against the paper S with an intense force because the spur axis 2a of the spur member 2 that is connected to the spring 3 can move along the elongated hole 1b formed in the paper scraping-off nail member 1. Therefore, it is possible to avoid the occurrence of a paper jam malfunction or error. In addition, it is further possible to reduce the formation of any impression or trace caused by the spur wheels 2b onto the paper S.

As described above, it is possible to prevent the spur member 2 from forming any impression or trace onto the paper S because the spur member 2 can move relative to the paper scraping-off nail member 1. In addition thereto, because the spur axis 2a of the spur member 2 that is connected to the spring 3 is configured in such a manner that it is able to move along the elongated hole 1b formed in the paper scraping-off nail member 1, just with a simple configuration, it is possible to reduce the formation of any impression or trace caused by the spur wheels 2b of the spur member 2 onto the paper 5, and further to avoid the occurrence of a paper jam malfunction or error.

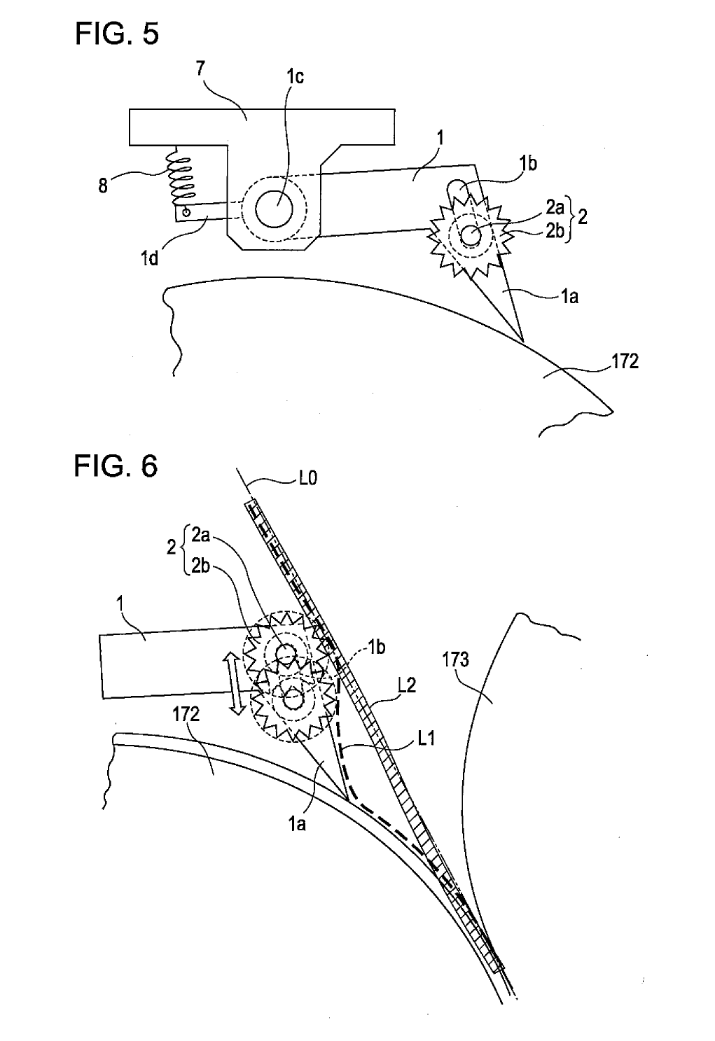

Next, another exemplary embodiment of the invention is described below. FIG. 5 is an enlarged view of the paper scraping-off nail member 1 according to a second embodiment of the invention, which is modified from the first embodiment thereof mainly in terms of the orientation of the elongated hole 1b. The elongated hole 1b of the paper scraping-off nail member 1 according to the present embodiment of the invention is formed to be substantially parallel to the nip portion coupling line L0. In addition thereto, the paper scraping-off nail member 1 according to the present embodiment of the invention has a middle portion 1c that is supported by a holder 7 in such a manner that the paper scraping-off nail member 1 pivots on its middle portion 1c. Further in addition, the end portion 1d of the paper scraping-off nail member 1 and the holder 7 are coupled to each other by means of a supporting spring 8. As an example of alternative configurations, the spring 3 may be provided inside the elongated hole 1b as in the first embodiment of the invention described above.

Next, the operation of the image fixation apparatus according to the second embodiment of the invention is described below. FIG. 6 is a diagram that schematically illustrates the operation of the spur member 2 with respect to the transport channel of the paper S. Firstly, a reference is made to the first paper transport channel L1 on which a normal plain paper travels. After passing through the nip portion of the image fixation roller T, the paper S is transported while being adhered to the heating roller 172 until it is separated therefrom by the tip portion 1a of the paper scraping-off nail member 1. After being scraped off by the tip portion 1a of the paper scraping-off nail member 1 from the heating roller 172, the paper S becomes in contact with the spur wheels 2b of the spur member 2. In this way, it is possible to prevent the tip portion 1a of the paper scraping-off nail member 1 from becoming in contact with the image surface of the paper S. Subsequently, the paper S passes through the guide member 4, which is not shown in the drawing, and transported toward the after-image-fixation roller 5.

Next, a reference is made to the second paper transport channel L2 on which a thick-type paper travels. After passing through the nip portion of the image fixation roller T, the paper S is immediately separated by itself from the heating roller 172. Then, the paper S is transported toward the after-image-fixation roller 5, which is not shown in the drawing. During transport of the paper S, it becomes in contact with the spur wheels 2b of the spur member 2. However, the spur wheels 2b do not get pressed against the paper S with an intense force because the spur axis 2a of the spur member 2 can move along the elongated hole 1b formed in the paper scraping-off nail member 1 and further because the paper scraping-off nail member 1 that is connected to the supporting spring 8 can move in a swinging manner. Therefore, it is possible to avoid the occurrence of a paper jam malfunction or error. In addition, it is further possible to reduce the formation of any impression or trace caused by the spur wheels 2b onto the paper S.

As described above, it is possible to prevent the spur member 2 from forming any impression or trace onto the paper S because the spur member 2 can move relative to the paper scraping-off nail member 1 (the spur member 2 and the paper scraping-off nail member 1 can move relative to each other). In addition thereto, because the spur axis 2a of the spur member 2 is configured in such a manner that it is able to move along the elongated hole 1b formed in the paper scraping-off nail member 1, just with a simple configuration, it is possible to reduce the formation of any impression or trace caused by the spur wheels 2b of the spur member 2 onto the paper S, and further to avoid the occurrence of a paper jam malfunction or error.

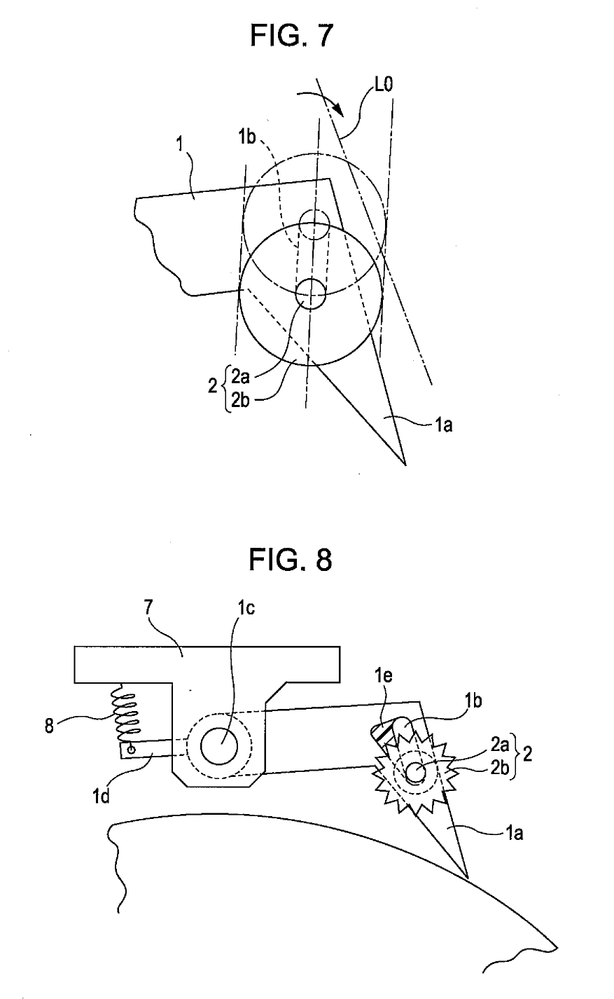

It should be noted that the orientation of the elongated hole 1b is not limited to the above example but may be modified as long as the spur wheels 2b do not get pressed against the paper S with an intense force. As an example of alternative configurations, as illustrated in FIG. 7, the orientation of the elongated hole 1b may be modified in such a manner that the spur wheels 2b become closer to the nip portion coupling line L0 as they move toward the downstream side of the paper transport channel.

FIG. 8 is an enlarged view of the paper scraping-off nail member 1 according to a third embodiment of the invention, which is modified from the second embodiment thereof mainly in terms of an elastic member 1e provided in the elongated hole 1b. The elongated hole 1b of the paper scraping-off nail member 1 according to the present embodiment of the invention, which is oriented substantially along the nip portion coupling line L0, has a gradually increasing width which becomes largest at the downstream end thereof. In addition thereto, the paper scraping-off nail member 1 according to the present embodiment of the invention has the middle portion 1c that is supported by the holder 7 in such a manner that the paper scraping-off nail member 1 pivots on its middle portion 1c. Further in addition, the end portion 1d of the paper scraping-off nail member 1 and the holder 7 are coupled to each other by means of the supporting spring 8. Further in addition, the elastic member 1e that is made of rubber, resin, or the like is provided at one side of the downstream widest end portion of the elongated hole 1b that is farther from the nip portion coupling line L0 than the opposite side thereof.

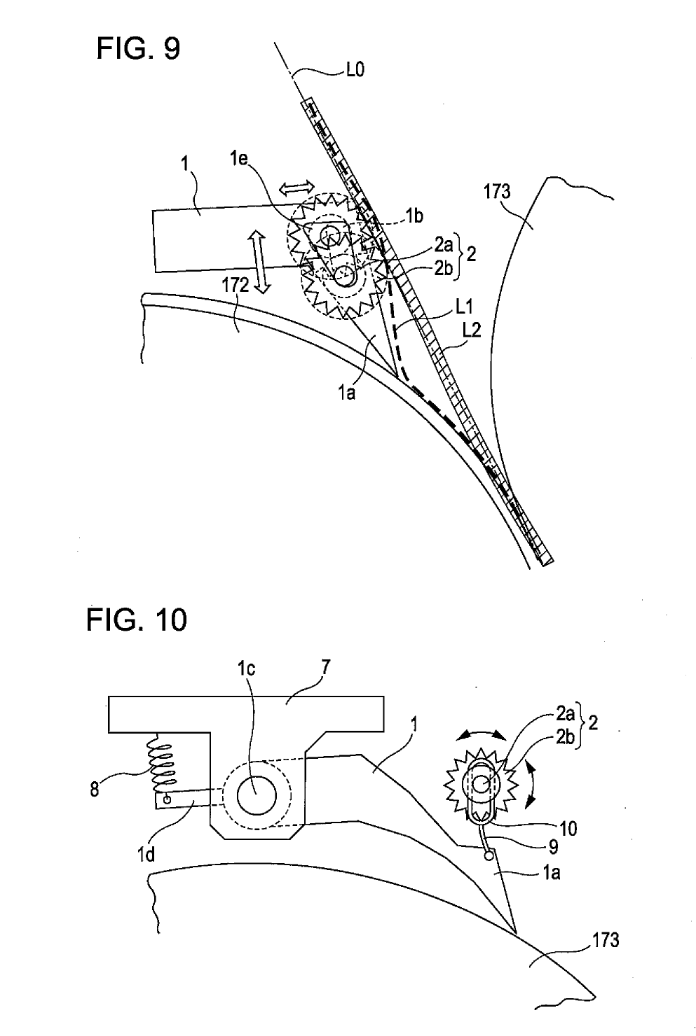

Next, the operation of the image fixation apparatus according to the third embodiment of the invention is described below. FIG. 9 is a diagram that schematically illustrates the operation of the spur member 2 with respect to the transport channel of the paper S.

Firstly, a reference is made to the first paper transport channel L1 on which a normal plain paper travels. After passing through the nip portion of the image fixation roller T, the paper S is transported while being adhered to the heating roller 172 until it is separated therefrom by the tip portion 1a of the paper scraping-off nail member 1. After being scraped off by the tip portion 1a of the paper scraping-off nail member 1 from the heating roller 172, the paper S becomes in contact with the spur wheels 2b of the spur member 2. In this way, it is possible to prevent the tip portion 1a of the paper scraping-off nail member 1 from becoming in contact with the image surface of the paper S. Subsequently, the paper S passes through the guide member 4, which is not shown in the drawing, and transported toward the after-image-fixation roller 5.

Next, a reference is made to the second paper transport channel L2 on which a thick-type paper travels. After passing through the nip portion of the image fixation roller T, the paper S is immediately separated by itself from the heating roller 172. Then, the paper S is transported toward the after-image-fixation roller 5, which is not shown in the drawing. During transport of the paper S, it becomes in contact with the spur wheels 2b of the spur member 2. However, the spur wheels 2b do not get pressed against the paper S with an intense force because of the following reasons. Firstly, it is because the spur axis 2a of the spur member 2 can move along the elongated hole 1b formed in the paper scraping-off nail member 1. Secondly, it is because the paper scraping-off nail member 1 that is connected to the supporting spring S can move in a swinging manner. Thirdly, the elastic member 1e allows the spur axis 2a (spur wheels 2b) of the spur member 2 to move away from the paper S. For these reasons, it is possible to avoid the occurrence of a paper jam malfunction or error. In addition, it is further possible to reduce the formation of any impression or trace caused by the spur wheels 2b onto the paper S.

As described above, the paper scraping-off nail member 1 and its peripheral components (and thus the image fixation apparatus) according to the present embodiment of the invention is configured in such a manner that, firstly, the spur axis 2a of the spur member 2 can move along the elongated hole 1b formed in the paper scraping-off nail member 1, secondly, the paper scraping-off nail member 1 that is connected to the supporting spring 8 can move in a swinging manner, and, thirdly, the elastic member 1e allows the spur axis 2a (spur wheels 2b) of the spur member 2 to move away from the paper S. Thanks to such a configuration, which is quite simple, it is possible to reduce the formation of any impression or trace caused by the spur wheels 2b of the spur member 2 onto the paper S, and further to avoid the occurrence of a paper jam malfunction or error.

FIG. 10 illustrates the paper scraping-off nail member 1 and its peripheral components according to a fourth embodiment of the invention, in which the spur member 2 is supported by a plate spring member 9 that is provided on the paper scraping-off nail member 1. In the configuration of the present embodiment of the invention, a supporting member 10 having the shape of an elongated hole is provided at one end of the plate spring member 9, whereas the other end thereof is mounted on the paper scraping-off nail member 1. The spur axis 2a of the spur member 2 penetrates through the elongated hole portion of the supporting member 10 in such a manner that the spur wheels 2b thereof can rotate. In addition thereto, the paper scraping-off nail member 1 according to the present embodiment of the invention has the middle portion 1c that is supported by the holder 7 in such a manner that the paper scraping-off nail member 1 pivots on its middle portion 1c. Further in addition, the end portion 1d of the paper scraping-off nail member 1 and the holder 7 are coupled to each other by means of the supporting spring 8.

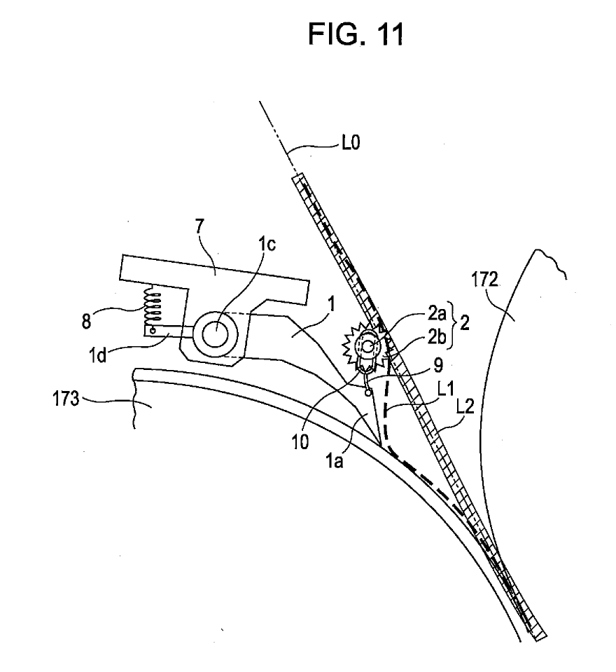

Next, the operation of the image fixation apparatus according to the fourth embodiment of the invention is described below. FIG. 11 is a diagram that schematically illustrates the operation of the spur member 2 with respect to the transport channel of the paper S.

Firstly, a reference is made to the first paper transport channel L1 on which a normal plain paper travels. After passing through the nip portion of the image fixation roller T, the paper S is transported while being adhered to the heating roller 172 until it is separated therefrom by the tip portion 1a of the paper scraping-off nail member 1. After being scraped off by the tip portion 1a of the paper scraping-off nail member 1 from the heating roller 172, the paper S becomes in contact with the spur wheels 2b of the spur member 2. In this way, it is possible to prevent the tip portion 1a of the paper scraping-off nail member 1 from becoming in contact with the image surface of the paper S. Subsequently, the paper S passes through the guide member 4, which is not shown in the drawing, and transported toward the after-image-fixation roller 5.

Next, a reference is made to the second paper transport channel L2 on which a thick-type paper travels. After passing through the nip portion of the image fixation roller T, the paper S is immediately separated by itself from the heating roller 172. Then, the paper S is transported toward the after-image-fixation roller 5, which is not shown in the drawing. During transport of the paper S, it becomes in contact with the spur wheels 2b of the spur member 2. However, the spur wheels 2b do not get pressed against the paper S with an intense force because of the following reasons. Firstly, it is because the spur axis 2a of the spur member 2 can move along (i.e., as guided by) the supporting member 10 having the shape of the elongated hole that is provided at the above-mentioned one end of the plate spring member 9, the other end of which is mounted on the paper scraping-off nail member 1. Secondly, it is because the paper scraping-off nail member 1 that is connected to the supporting spring 8 can move in a swinging manner. Thirdly, the plate spring member 9 allows the spur axis 2a (spur wheels 2b) of the spur member 2 to move away from the paper S. For these reasons, it is possible to avoid the occurrence of a paper jam malfunction or error. In addition, it is further possible to reduce the formation of any impression or trace caused by the spur wheels 2b onto the paper S.

As described above, the paper scraping-off nail member 1 and its peripheral components (and thus the image fixation apparatus) according to the present embodiment of the invention is configured in such a manner that, firstly, the spur axis 2a of the spur member 2 can move along (i.e., as guided by) the supporting member 10 having the shape of the elongated hole that is provided at the above-mentioned one end of the plate spring member 9, the other end of which is mounted on the paper scraping-off nail member 1, secondly, the paper scraping-off nail member 1 that is connected to the supporting spring 8 can move in a swinging manner, and, thirdly, the plate spring member 9 allows the spur axis 2a (spur wheels 2b) of the spur member 2 to move away from the paper S. Thanks to such a configuration, which is quite simple, it is possible to reduce the formation of any impression or trace caused by the spur wheels 2b of the spur member 2 onto the paper S, and further to avoid the occurrence of a paper jam malfunction or error.

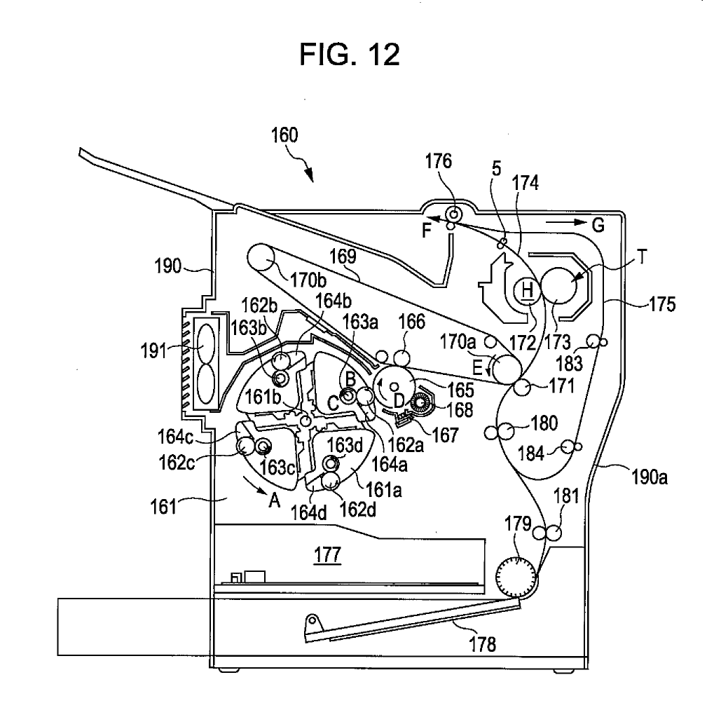

FIG. 12 is a vertically sectional side view that schematically illustrates the longitudinal section of an image formation apparatus to which the invention is applicable. As shown in FIG. 12, an image formation apparatus 160 is provided with, as its main components, an image developer (developing unit) 161 having a rotary configuration, a photosensitive drum 165 that functions as an image carrier, an image writing unit (line head) 167 that is provided with an organic EL array exposure head, an intermediary image-transfer belt 169 that functions as an intermediary image-transfer unit, a paper transport channel 174, a heating roller 172 of the image fixation apparatus, and a paper-feed tray 178.

In the configuration of the image developer 161, an image developing rotary unit 161a rotates in the direction shown by the arrow A around its axis 161b. The inner configuration of the image developing rotary unit 161a is divided into four compartments. Four color image formation units, that is made up of a yellow (Y) image formation unit, a cyan (C) image formation unit, a magenta (M) image formation unit, and a black (K) image formation unit, are housed in these compartments. Reference numerals 162a-162d denote image developing rollers each of which is provided in the corresponding one of the above-mentioned four color image formation units. Each of these image developing rollers 162a-162d functions as a toner carrier that rotates in the direction shown by the arrow B. Reference numerals 163a-163d denote toner supplying rollers each of which rotates in the direction shown by the arrow C. Reference numerals 164a-164d denote toner-thickness-controlling blades each of which controls the thickness of toner into a predetermined level.

The photosensitive drum 165 is driven by a driving motor that is not shown in the drawing in the direction shown by the arrow D, which is the direction opposite to the rotation direction of the image developing roller 162a. An example of the driving motor is a step motor. The intermediary image-transfer belt 169 is stretched between a driving roller (i.e., master roller) 170a and a driven roller (i.e., slave or follower roller) 170b. The driving roller 170a is coupled to the above-mentioned driving motor of the photosensitive drum 165 so as to communicate a motive power (i.e., driving force) to the intermediary image-transfer belt 169. Driven by the driving motor, the driving roller 170a of the intermediary image-transfer belt 169 rotates in the direction shown by the arrow E, which is the direction opposite to the rotation direction of the photosensitive drum 165.

In the configuration of the image formation apparatus 160 described above, the operational flow from the image developer 161 to the intermediary image-transfer belt 169 is explained below. First of all, the toner supplying roller 163 supplies toner to the image developing roller 162. At this time, the controlling blade 164 adjusts the thickness of the toner so as to control the amount thereof. The image developing roller 162 develops an electrostatic latent image that is formed on the photosensitive drum 165 by the line head 167 or the like. The developed image on the photosensitive drum 165 is then transferred to the intermediary image-transfer belt 169.

The paper transport channel 174 is provided with a plurality of paper transport rollers, (a pair of) paper-eject roller 176, and the like. The single-sided image that is carried by the intermediary image-transfer belt 169 (toner image) is transferred onto one side of a print target paper at the position of a secondary image-transfer roller 171. The secondary image-transfer roller 171 becomes in contact with, and not in contact with, the intermediary image-transfer belt 169 by means of the mechanical operation of a clutch. When the clutch is activated, the secondary image-transfer roller 171 becomes in contact with the intermediary image-transfer belt 169 so that the image is transferred to the print target paper.

The print target paper on which the image is transferred as described above is then subjected to image fixation processing performed by the image fixation apparatus that is provided with the above-mentioned image fixation heater H. The image fixation apparatus has the heating roller 172 and the pressure-applying roller 173. The pressure-applying roller 173 has a reverse crown shape. After being subjected to the image fixation processing, the paper is transported toward the downstream side by the after-image-fixation roller 5. Then, the paper is pulled into the paper-eject roller 176 to be further transported in the direction shown by the arrow F. In such a state, if the paper-eject roller 176 rotates in the reverse direction, the transport direction of the paper is reversed. After inversion of its transport direction, the paper moves on a two-sided (i.e., double face) printing transport channel 175 in the direction shown by the arrow G. Reference numeral 183 denotes a first double face printing transport roller. Reference numeral 184 denotes a second double face printing transport roller. Reference numeral 177 denotes an electric component box. Reference numeral 178 denotes a paper-feed tray in which sheets of paper waiting to be printed are stacked. Reference numeral 179 denotes a pickup roller that is provided at the exit of the paper-feed tray 178. A housing case 190 is provided with an exhaust ventilation fan 191. At the paper-transport-channel (174) side of the housing case 190, a door 190a is provided. The door 190a is opened when pulling out a stuck paper therethrough at the time of the occurrence of a paper jam malfunction.

A paper-feed roller 181 is provided on the single-sided paper transport channel 174 at a downstream position viewed from the pickup roller 179. A gate roller 180 is provided at an upstream position viewed from the secondary image-transfer roller 171.

Although a line head that employs light emitting devices as its light exposing means is provided in the exemplary configuration illustrated in FIG. 12, the invention is not limited to such a configuration. For example, an optical scanning system that uses a laser beam as its light source may be provided in place thereof.

Although an image fixation apparatus and an image fixation method as well as an image formation apparatus and an image formation method according to exemplary embodiments of the present invention are described above, needless to say, the invention is in no case restricted to these exemplary embodiments described herein; the invention may be configured and implemented in an adaptable manner in a variety of variations without departing from the spirit thereof.

What is claimed is:

1. An image fixation apparatus comprising:
an image fixation roller that is made up of a heating roller having a heating element and a pressure-applying roller that is opposed to the heating roller, the heating roller and the pressure-applying roller forming a nip portion;
a separation member that contacts the heating roller; and
a wheel member provided at a downstream of the separation member, the wheel member having a wheel that rotates when becoming in contact with an image-transfer target material,
wherein the wheel member can move relative to the separation member.

2. The image fixation apparatus according to claim 1, wherein the wheel member is supported by an elastic member in such a manner that it can move relative to the separation member.

3. The image fixation apparatus according to claim 1, wherein the separation member has an elongated hole, and the wheel member can move relative to the separation member along the elongated hole.

4. The image fixation apparatus according to claim 3, wherein the elongated hole has an elastic member inside thereof.

5. The image fixation apparatus according to claim 1, further comprising an after-image-fixation roller provided at a downstream of the heating roller and the pressure-applying roller, wherein the wheel member can move relative to the separation member in a direction substantially parallel to a nip portion coupling line that passes through a nip portion outlet that is formed by the heating roller and the pressure-applying roller and a nip portion inlet of the after-image-fixation roller.

6. The image fixation apparatus according to claim 1, further comprising an after-image-fixation roller provided at a downstream of the heating roller and the pressure-applying roller, wherein the wheel member can move relative to the separation member in a direction substantially perpendicular to a nip portion coupling line that passes through a nip portion outlet that is formed by the heating roller and the pressure-applying roller and a nip portion inlet of the after-image-fixation roller.

7. An image formation apparatus that is provided with the image fixation apparatus according to claim 1, the image formation apparatus comprising:
an image carrier;
a developer carrier that develops a latent image formed on the image carrier;
an intermediary image-transfer section that transfers an image developed on the image carrier by the developer carrier;
a secondary image-transfer section that transfers an image on the intermediary image-transfer section to an image-transfer target material; and
the above-mentioned image fixation apparatus that fixes an image on the image-transfer target material.

8. An image fixation method comprising:
an image-transfer target material passing through a nip portion formed by a heating roller having a heating element and a pressure-applying roller that is opposed to the heating roller; and
the image-transfer target material becoming in contact with a wheel member that is provided at a downstream of a separation member, the wheel member being able to move relative to the separation member.
